(19) United States
(12) Patent Application Publication
(10) Pub. No.: US 2002/0130250 A1
(43) Pub. Date: Sep. 19, 2002

(54) Method for detecting a wafer

(76) Inventors: Chih-Ming Chung, Hsin-Chu City (TW); Wei-Tsung Chen, Hsin-Chu Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 09/803,879

(22) Filed: Mar. 13, 2001

(51) Int. Cl. H01J 40/14

(52) U.S. Cl. 250/221

(57) ABSTRACT

A method for detecting the position of a wafer in the slot of a wafer boat. The method comprises: Providing a first light source and second light source. Using a beam splitter apparatus for separating the light emitted from the first light source into a first light beam and a second light beam. Using a first sensor to receive the first light beam and functions in detecting the existence of the wafer in the slot of the wafer boat. Using a second sensor to receive the second light beam and functions in detecting the number of wafers in the slot of the wafer boat. Using a third sensor to receive the light emitted from the second light source to detect whether there is a protrusion of the wafer from the wafer boat.

### BACKGROUND OF THE INVENTION

1. Field of the Invention

The present invention provides a method for detecting a wafer.

2. Description of the Prior Art

In a semiconductor process, the wafers are nearly transported automatically in order to avoid any probability of wafer contamination with the consideration of cleaning. With this consideration, there is usually a mechanism for detecting the actual position of the wafer stored in a wafer boat of a semiconductor process equipment. All of the detecting signals are sent to a wafer transportation system, which subsequently makes calculations and produces an instruction as to the next step along the transportation system. Therefore, the sensitivity of the wafer detecting system is extremely important to detect the actual positions of the large quantities of wafers in the wafer boat, as well as ensuring the proper operation of the wafer transportation system without the occurrence of equipment inefficiency and broken wafers. In other words, all of the factors which result in the damage and failure of the wafer detecting apparatus need to be removed to produce both a smooth functioning wafer detecting device and wafer transportation system.

In the method for detecting a wafer according to the prior art, a beam splitter apparatus comprising a plurality of beam splitters or mirrors is normally applied in order to separate light to each of the sensors. When light incidents on a first beam splitter, it is reflected as a first light beam to a first sensor, while the light not reflected by the first beam splitter passes through the first splitter and becomes a second light beam to a second beam splitter. The second light beam incidents on the second beam splitter and is reflected to a second sensor. The light that passes through and is not reflected by the second beam splitter becomes another light source and passes through another beam splitter or optical device in order to achieve another detecting goal.

Please refer to FIG. 1 of a schematic diagram of a wafer detecting apparatus 10 according to the prior art. As shown in FIG. 1, the wafer detecting apparatus 10 according to the prior art comprises a laser diode 12, a beam splitter apparatus 14 which comprises a beam splitter 16 and beam splitter 18, a set of mirrors 22, a first sensor 24, a second sensor 26 and a third sensor 28. Herein, a wafer 32 is positioned in a wafer boat 34. The first sensor 24 is a wafer detector that detects the existence of the wafer 32 in the slot of the wafer boat 34. The second sensor 26 is a slot detector that detects whether the wafer 32 is correctly positioned in the slot of the wafer boat 34. The third sensor 28 is a protrusion detector that detects whether there is a protrusion of the wafer 32 from the wafer boat 34.

When light is emitted from the laser diode 12, it passes to the beam splitter apparatus 14 which comprises the beam splitter 16 and the beam splitter 18. The beam splitter 16 separates the light emitted from the laser diode 12 into a first light beam which is reflected to the first sensor 24, and a second light beam which passes through the beam splitter 16 to the beam splitter 18 continuously. The first sensor 24 functions in detecting the existence of the wafer 32 in the slot of the wafer boat 34, whereby if the wafer 32 does exist in the slot of the wafer boat 34, the first light beam becomes obstructed by the wafer 32 and is unable to reach the first sensor 24. Oppositely, if the wafer 32 does not exist in the slot of the wafer boat 34, the first light beam does not become obstructed by the wafer 32 and the first sensor 24 detects the light.

Similarly, the beam splitter 18 separates the light emitted from the second light beam into a third light beam, which is reflected to the second sensor 26, and a fourth light beam which goes to the set of reflective mirrors 22. The second sensor 26 functions in detecting whether the wafer 32 is correctly positioned in the slot of the wafer boat 34, and if for instance two wafers 32 are simultaneously positioned in the slot of the wafer boat 34, the third light beam becomes obstructed by a portion of the mispositioned wafer 32 and is unable to reach the second sensor 26. Oppositely, if there are not two wafers 32 simultaneously positioned in the slot of the wafer boat 34, the third light beam does not become obstructed by any portion of the wafer 32 and the second sensor 26 detects the third light beam. Herein, little difference occurs between the vertical positioning of the first sensor 24 and the second sensor 26, so that the first light beam and the third light beam is detected separately.

Finally, the fourth light beam which is formed by a portion of the second light beam that has passed through the beam splitter 18, changes its propagational direction according to the reflective orientation of the set of reflective mirrors 22. Its propagational direction becomes opposite and 180 degrees to the light emitted from the laser diode 12 to reach the third sensor 28. The third sensor 28 functions in detecting whether there is a protrusion of the wafer 32 from the wafer boat 34, so if for instance a protrusion of the wafer 32 does occur from the wafer boat 34, the fourth light beam becomes obstructed by the wafer 32 and is unable to reach the third sensor 28. Oppositely, if there is no protrusion of the wafer 32 from the wafer boat 34, the fourth light beam does not become obstructed by the wafer 32 and the third sensor 28 detects the fourth light beam.

The wafer detecting apparatus 10 according to the prior art method for detecting a wafer makes use of the combination of the beam splitter 16, beam splitter 18 and the set of reflective mirrors 22. When light passes through the stacked mirror structure, the light emitted from the laser diode 12 is split and continuously reflected. The wafer detecting apparatus 10 begins its operation properly and correctly, but with increasing utilization time, particles or moisture accumulates on the mirrors to result in signal attenuation and equipment inefficiency. In order to resolve this problem, the stacked mirror structure needs to be decreased to reduce the probability of particle and moisture accumulation on the mirrors. Concurrently, the sources of the light beams cannot be lost. Therefore, a laser diode 22 is used instead of a pair of surface mirrors to provide the required light source and to reduce the stacked mirror structure.

### SUMMARY OF THE INVENTION

It is therefore a primary objective of the present invention to provide a method of applying a laser diode as a light source in a method for detecting a wafer to resolve the above-mentioned problem.

In a preferred embodiment, a wafer detecting apparatus appling the method for detecting a wafer according to the present invention comprises a first light source, a beam splitter apparatus for separating the light emitted from the first light source into a first light beam and a second light beam, a first sensor for receiving the first light beam in order to detect the existence of a wafer in the slot of a wafer boat, a second sensor for receiving the second light beam in order to detect the number of wafers in the slot of the wafer boat, a second light source and a third sensor for receiving the light beam emitted from the second light source in order to detect a protrusion of the wafer from the wafer boat.

It is an advantage of the present invention that a laser diode is used instead of a set of reflective mirrors. Thus, not only is enough light source energy provided to the wafer detecting apparatus, but also the stacked mirror structure is reduced. The result is a large reduction in the probability of particles and moisture accumulating on the mirrors, so that the complexity of maintenance and calibration of each mirror set is also reduced to prevent equipment inefficiency occurring from signal attenuation. Therefore, the wafer detecting apparatus applying the method for detecting a wafer according to the present invention produces smoother wafer transportation, whereby no extra manpower is required for trouble-shooting, as well as a decrease in the unnecessary loss of throughput.

These and other objectives of the present invention will no doubt become obvious to those of ordinary skill in the art after reading the following detailed description of the preferred embodiment, which is illustrated in the various figures and drawings.

### BRIEF DESCRIPTION OF THE DRAWINGS

FIG. 1 is the schematic diagram of the wafer detecting apparatus applying the method for detecting a wafer according to the prior art.

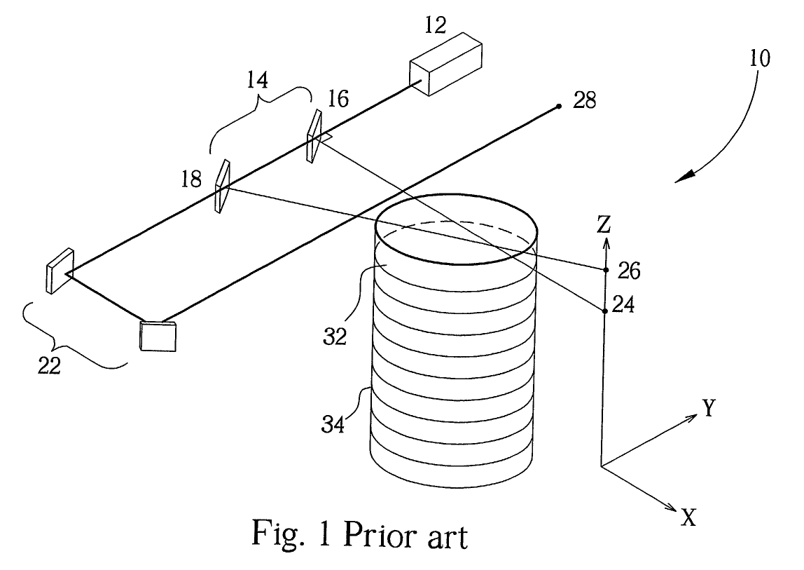

FIG. 2 is the schematic diagram of the wafer detecting apparatus applying the method for detecting a wafer according to the present invention.

### DETAILED DESCRIPTION OF THE PREFERRED EMBODIMENT

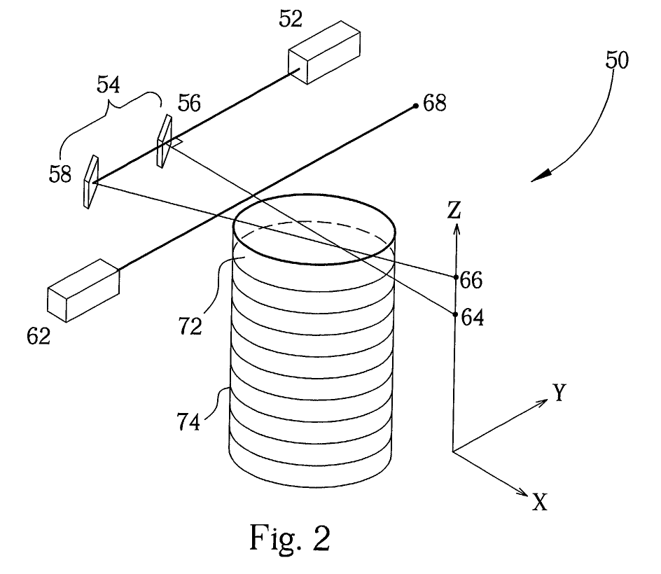

Please refer to FIG. 2 of the schematic diagram of the wafer detecting apparatus 50 applying the method for detecting a wafer according to the present invention. As shown in FIG. 2, the wafer detecting apparatus 50 according to the present invention comprises a first laser diode 52, a second laser diode 62, a beam splitter apparatus 54 comprising a beam splitter 56 and a mirror 58, a first sensor 64, a second sensor 66, and a third sensor 68. Herein, the wafer 72 is positioned in the slot of the wafer boat 74. The first sensor 64 is a wafer sensor to detect the existence of the wafer 72 in the slot of the wafer boat 74. The second sensor 66 is a slot sensor for detecting whether the wafer 72 is correctly positioned in the slot of the wafer boat 74. The third sensor 68 is a protrusion sensor for detecting whether there is a protrusion of the wafer 72 from the wafer boat 74.

When light is emitted from the laser diode 52, it reaches the beam splitter apparatus 54 which comprises a beam splitter 56 and a mirror 58. The beam splitter 56 separates the light emitted from the first laser diode 52 into a first light beam, which is reflected to the first sensor 64, and a second light beam which passes through the beam splitter 56 to the mirror 58 continuously and reflected to the second sensor 66. The first sensor 64 functions in detecting the existence of the wafer 72 in the slot of the wafer boat 74, so if the wafer 72 does exist in the slot of the wafer boat 74, the first light beam becomes obstructed by the wafer 72 and is unable to reach the first sensor 64. Oppositely, if no wafer 72 exists in the slot of the wafer boat 74, the first light beam does not become obstructed by the wafer 72, so the first sensor 64 detects the first light beam.

Subsequently, the second light beam emitted from the beam splitter 56 is reflected completely by a mirror 58 to the second sensor 66. The second sensor 66 functions in detecting whether the wafer 72 is correctly positioned in the slot of the wafer boat 74, so for instance if two wafer 72 simultaneously exist in one slot of the wafer boat 74, the second light beam becomes obstructed by some portion of the mispositioned wafer 72 and is unable to reach the second sensor 66. Oppositely, if there are not two wafer 72 simultaneously existing in the slot of the wafer boat 74, the second beam does not become obstructed by any portion of the wafer 72, and the second sensor 66 detects the second beam. Herein, little difference occurs between the vertical positioning of the first sensor 64 and the second sensor 66, so that the first light beam and the second light beam are detected separately.

The light emitted from the second laser diode 62 is the third light beam and directly incidents on the third sensor 68. The third sensor 68 functions in detecting whether there is a protrusion of the wafer 72 from the wafer boat 74, whereby the third light beam first passes a specific point beyond the wafer boat 74 before going to the third sensor 68. If there is a protrusion of the wafer 72 from the wafer boat 74, the third light beam becomes obstructed by the wafer 72 and is unable to reach the third sensor 68. Oppositely, if there is no protrusion of the wafer 72 from the wafer boat 74, the third light beam does not become obstructed by the wafer 72 and the third sensor 68 detects the third light beam.

Since the wafer detecting apparatus applying the method for detecting a wafer according to the present invention applies a laser diode instead of a set of reflective mirrors, it's less likely to lead to particle or moisture accumulation on the mirrors and result in equipment inefficiency due to signal attenuation of the light passing through the stacked mirror structure. Moreover, the apparatus structure applying the method for detecting a wafer in this invention greatly reduces the complexity of maintenance and calibration of each mirror set in the wafer detecting apparatus to efficiently reduce the maintenance cost.

In contrast to the method for detecting a wafer according to the prior art, the method for detecting a wafer of the present invention applies a laser diode instead of a set of reflective mirrors. Therefore, not only is enough light source energy provided to the wafer detecting apparatus, but also the stacking mirror structure is decreased. The result is a great reduction in both the probability of particle and moisture accumulation on the mirrors, as well as a decrease in the complexity of the maintenance and calibration of each mirror, to prevent equipment inefficiency occurring from signal attenuation. Therefore, the method for detecting a wafer according to the present invention allows for smoother wafer transportation, whereby no extra manpower is required for trouble-shooting, with a decrease in unnecessary loss of throughput.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for detecting the position of a wafer stored in a slot of a wafer boat, the method comprising:
providing a first light source and a second light source;
using a beam splitter apparatus to separate light emitted from the first light source into a plurality of beams, the plurality of beams comprising a beam A and a beam B;
using a first sensor to receive the beam A from the beam splitter apparatus to detect the existence of the wafer in the slot of the wafer boat;
using a second sensor to receive the beam B from the beam splitter apparatus to detect the number of wafers in one slot of the wafer boat; and
using a third sensor to receive light emitted from the second light source to detect a protrusion of the wafer from the wafer boat.

2. The method of claim 1 wherein the beam splitter apparatus comprises a beam splitter and a mirror, the beam splitter is used to separate light emitted from the first light source into the beam A and the beam C, the beam A goes to the first sensor, and the beam C reflects off the mirror to become beam B, which goes to the second sensor.

3. The method of claim 1 wherein the first light source and the second light source are both laser diodes.

4. A method for detecting the position of a wafer stored in a slot of a wafer boat, the method comprising:
providing a first light source and a second light source;
using a beam splitter apparatus to separate light emitted from the first light source into a plurality of beams;
using a first sensor and a second sensor to receive beams from the beam splitter apparatus; and
using a third sensor to receive light emitted from the second light source.

5. The method of claim 4 wherein the beam splitter apparatus comprises a beam splitter and a mirror, the beam splitter is used to separate light emitted from the first light source into a beam A and a beam B, the beam A goes to the first sensor, and the beam B reflects off the mirror and goes to the second sensor.

6. The method of claim 4 wherein the first sensor is used to detect the existence of the wafer in the slot of the wafer boat, or to detect the number of wafers in one slot of the wafer boat, or to detect a protrusion of the wafer from the wafer boat.

7. The method of claim 4 wherein the second sensor is used to detect the existence of the wafer in the slot of the wafer boat, or to detect the number of wafers in one slot of the wafer boat, or to detect a protrusion of the wafer from the wafer boat.

8. The method of claim 4 wherein the third sensor is used to detect the existence of the wafer in the slot of the wafer boat, or to detect the number of wafers in one slot of the wafer boat, or to detect a protrusion of the wafer from the wafer boat.

9. The method of claim 4 wherein the first light source and the second light source are both laser diodes.

10. A method for detecting the position of a wafer stored in a slot of a wafer boat, the method comprising:
providing a first light source, a second light source, and third light source;
using a first sensor to receive light emitted from the first light source to detect the existence of the wafer in the slot of the wafer boat;
using a second sensor to receive light emitted from the second light source to detect the number of wafers in one slot of the wafer boat; and
using a third sensor to receive light emitted from the third light source to detect a protrusion of the wafer from the wafer boat.

11. The method of claim 10 wherein the first light source, the second light source and the third light source are all laser diodes.
